(19) United States
(12) Patent Application Publication
(10) Pub. No.: US 2026/0292094 A1
(43) Pub. Date: Sep. 24, 2026

(54) CONTROL METHOD, PROJECTION APPARATUS, AND NON-TRANSITORY COMPUTER-READABLE STORAGE MEDIUM STORING PROGRAM

(71) Applicant: SEIKO EPSON CORPORATION, Tokyo (JP)

(72) Inventor: Momoko IMAI, Matsumoto-shi (JP)

(73) Assignee: SEIKO EPSON CORPORATION, Tokyo (JP)

(21) Appl. No.: 19/574,608

(22) Filed: Mar. 23, 2026

(30) Foreign Application Priority Data
Mar. 24, 2025 (JP) 2025-048694

(51) Int. Cl. H04N 1/60; H04N 5/74

(52) U.S. Cl. CPC H04N 1/6005; H04N 5/74

(57) ABSTRACT

A control method is a method of controlling at least one projection apparatus configured to project a plurality of images different in brightness from each other, the method including: acquiring chromaticity at which the brightness of each of a plurality of correction target points becomes a target value; setting target chromaticity to chromaticity at which a chromaticity difference between the plurality of correction target points becomes minimum; and correcting the chromaticity at each of the plurality of correction target points based on the target chromaticity.

The present application is based on, and claims priority from JP Application Serial Number 2025-048694, filed Mar. 24, 2025, the disclosure of which is hereby incorporated by reference herein in its entirety.

### BACKGROUND

### 1. Technical Field

The present disclosure relates to a control method, a projection apparatus, and a non-transitory computer-readable storage medium storing a program.

### 2. Related Art

JP-A-2010-217644 discloses a color unevenness correction value generation system including a projector, a camera, and a color unevenness correction value generation apparatus. The color unevenness correction value generation apparatus sets average values of XYZ values in the entire screen or an area of a central portion of the screen as correction target values when the color unevenness correction is performed based on imaging data obtained by capturing the state of the color unevenness of an actual projection image with a camera.

JP-A-2010-217644 is an example of the related art.

In the technique described in JP-A-2010-217644, since the average value is set as the correction target value when the color unevenness correction is performed, when correcting the color unevenness of an image such as a black image the lowest in brightness, a correction amount which is a difference between an actual measurement value of the color unevenness and the average value may exceed an adjustable range of the color unevenness, and as a result, the color unevenness may not be appropriately corrected in some cases.

### SUMMARY

A preferred aspect of a control method according to the present disclosure is a method of controlling at least one projection apparatus configured to project a plurality of images different in brightness from each other, the method comprising: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity of each of the plurality of correction target points based on the target chromaticity.

A preferred aspect of a projection apparatus according to the present disclosure is a projection apparatus configured to project a plurality of images different in brightness from each other including at least one processor, wherein the processor is configured to execute: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity at each of the plurality of correction target points based on the target chromaticity.

A preferred aspect of a non-transitory computer-readable storage medium storing a program according to the present disclosure is a non-transitory computer-readable storage medium storing a program for controlling at least one projection apparatus including a processor and configured to project a plurality of images different in brightness from each other, the program causing the processor to execute processing including: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity at each of the plurality of correction target points based on the target chromaticity.

### BRIEF DESCRIPTION OF THE DRAWINGS

FIG. 1 is a diagram showing an overall configuration of a projection system used in a control method according to an embodiment.

FIG. 2 is a block diagram of a projection apparatus according to the embodiment.

FIG. 3 is a diagram illustrating a correctable chromaticity range between projection apparatuses.

FIG. 4 is a diagram illustrating a chromaticity correction when an average value of chromaticity of a plurality of projection apparatuses is used as a target value of the chromaticity.

FIG. 5 is a diagram illustrating the chromaticity correction when an arithmetic average value of a maximum value of the chromaticity and a minimum value of the chromaticity of the plurality of projection apparatuses is used as the target value of the chromaticity.

FIG. 6 is a flowchart showing a control method according to the embodiment.

FIG. 7 is a diagram showing an example of a plurality of correction target points.

FIG. 8 is a diagram showing an example of the plurality of correction target points.

FIG. 9 is a diagram showing an example of the plurality of correction target points.

FIG. 10 is a diagram illustrating projection of a measurement pattern by the projection apparatus.

FIG. 11 is a flowchart showing calculation of the correction value.

FIG. 12 is a diagram showing an example of a target value of brightness at the correction target point in an overlapping area.

FIG. 13 is a diagram showing a relationship between an input gradation and an output luminance in the overlapping area and a non-overlapping area.

FIG. 14 is a diagram showing an example of the target value of the brightness at the correction target point adjacent to the overlapping area out of the correction target points in the non-overlapping area.

FIG. 15 is a diagram illustrating calculation of the target value of the brightness at the correction target point in the non-overlapping area.

FIG. 16 is a diagram illustrating calculation of the target value of the brightness at the correction target point in the non-overlapping area.

FIG. 17 is a diagram illustrating calculation of the target value of the brightness at the correction target point in the non-overlapping area.

FIG. 18 is a diagram illustrating smoothing of the target value of the brightness at the correction target point.

FIG. 19 is a diagram illustrating the target chromaticity.

### DESCRIPTION OF EMBODIMENTS

Some aspects for implementing the present disclosure will hereinafter be described with reference to the drawings. Note that in each of the drawings, dimensions and scales of components are made different from actual ones as appropriate. Further, the embodiments described below are suitable specific examples of the present disclosure, and are therefore attached with technically preferable various limitations, but the scope of the present disclosure is not limited to these embodiments unless there is particularly a description to the effect that the present disclosure is limited in the following explanation.

### 1: FIRST EMBODIMENT

### 1-1: Overall Configuration of Projection System Used in Control Method

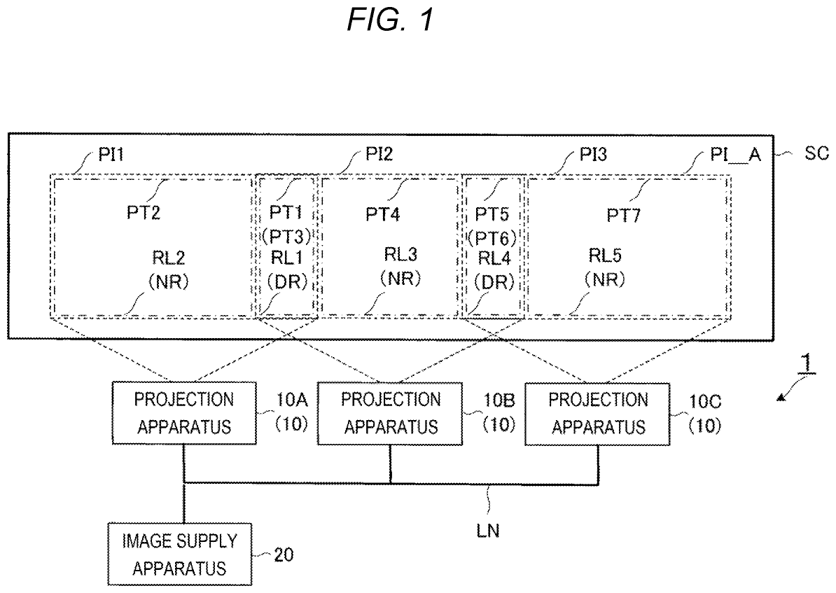

FIG. 1 is a diagram illustrating an overall configuration of a projection system 1 used in a control method according to an embodiment. The projection system 1 is a multi-projection system that projects a projection image PI_A on a projection surface SC. The projection system 1 includes a projection apparatus 10A, a projection apparatus 10B, a projection apparatus 10C, and an image supply apparatus 20. These are communicably coupled to each other via a communication line LN. Hereinafter, when the projection apparatuses 10A, 10B, and 10C are not distinguished from each other, each of them may be referred to as a projection apparatus 10 in some cases. Note that the number of projection apparatuses 10 provided to the projection system 1 is not limited to the illustrated example, and may be two or less or four or more.

Each of the projection apparatus 10A, the projection apparatus 10B, and the projection apparatus 10C is a projector that projects an image on the projection surface SC based on an image data from the image supply apparatus 20. The projection apparatus 10A, the projection apparatus 10B, and the projection apparatus 10C have substantially the same function. However, any one of the projection apparatus 10A, the projection apparatus 10B, and the projection apparatus 10C is a main apparatus, and can control operations of other projection apparatuses 10 as sub-apparatuses.

In a more specific description, the projection apparatus 10A projects a projection image PI1 onto the projection surface SC. The projection apparatus 10B projects a projection image PI2 onto the projection surface SC. The projection apparatus 10C projects a projection image PI3 onto the projection surface SC. Note that each of the projection images PI1, PI2, and PI3 may hereinafter be referred to as a projection image PI when not distinguished from one another.

Such projection images PI1, PI2, and PI3 have portions overlapping each other on the projection surface SC to thereby display the one projection image PI_A as a whole. Here, the projection image PI_A has areas RL1, RL2, RL3, RL4, and RL5.

In contrast, the projection image PI1 includes a portion PT1 belonging to the area RL1 of the projection image PI_A and a portion PT2 belonging to the area RL2 of the projection image PI_A. The projection image PI2 includes a portion PT3 belonging to the area RL1 of the projection image PI_A, a portion PT4 belonging to the area RL3 of the projection image PI_A, and a portion PT5 belonging to the area RL4 of the projection image PI_A. The projection image PI3 includes a portion PT6 belonging to the area RL4 of the projection image PI_A and a portion PT7 belonging to the area RL5 of the projection image PI_A.

As described above, the area RL1 of the projection image PI_A is an area (overlapping area DR) in which the portion PT1 of the projection image PI1 and the portion PT3 of the projection image PI2 overlap each other on the projection surface SC. The area RL4 of the projection image PI_A is an area (overlapping area DR) in which the portion PT5 of the projection image PI2 and the portion PT6 of the projection image PI3 overlap each other on the projection surface SC. Meanwhile, each of the area RL2, the area RL3, and the area RL5 of the projection image PI_A is a non-overlapping area NR in which only one of the projection images PI1, PI2, and PI3 is projected onto the projection surface SC.

The image supply apparatus 20 is a device having a function of performing division processing of dividing an image datum representing one image into a plurality of image data to be projected by the plurality of projection apparatuses 10 and a function of supplying each of the image data obtained by the division processing to the corresponding one of the projection apparatuses 10. The image supply apparatus 20 may be, for example, a laptop or desktop computer, a smartphone, or a tablet terminal, or may be a video player, a digital versatile disk (DVD) player, a Blu-ray disc player, a hard disk recorder, a television tuner, a set-top box for a cable television (CATV), or a video game machine.

Note that the image supply apparatus 20 may supply the image data to the respective projection apparatus 10A, the projection apparatus 10B, and the projection apparatus 10C, or may supply the image data only to the projection apparatus 10 as the main apparatus. When the image supply apparatus 20 supplies the image data only to the projection apparatus 10 as the main apparatus, it is sufficient for the projection apparatus 10 as the main apparatus to appropriately distribute the image data from the image supply apparatus 20 respectively to the plurality of projection apparatuses 10 as the sub apparatuses.

Further, the image supply apparatus 20 is provided as necessary, and may be omitted. In this case, the image data may be stored in advance in the projection apparatus 10A, the projection apparatus 10B, and the projection apparatus 10C, respectively, or the image data for the respective projection apparatuses 10A, 10B, and 10C may be stored in the projection apparatus 10 as the main apparatus.

### 1-2: Configuration of Projection Apparatus

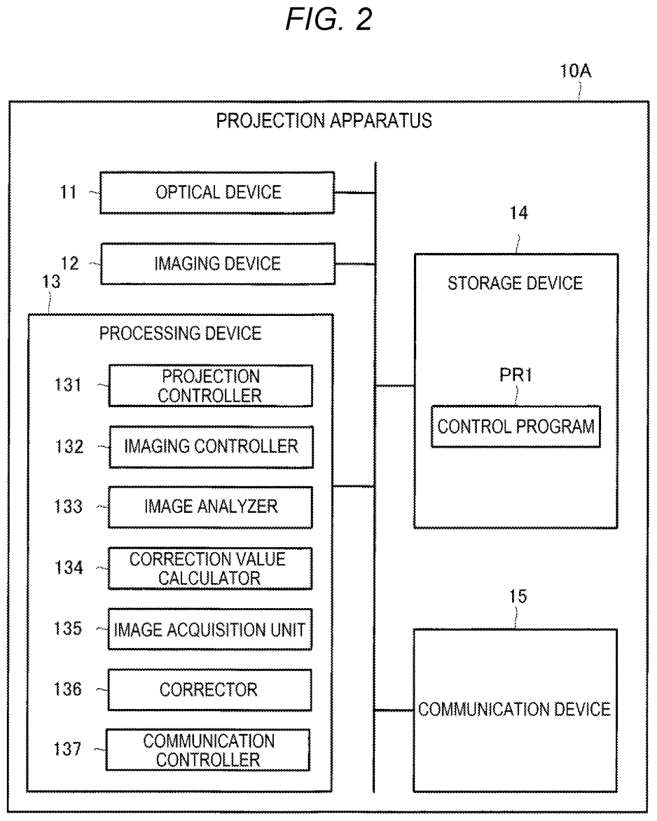

FIG. 2 is a block diagram of the projection apparatus 10A according to the embodiment. Note that each of the projection apparatus 10B and the projection apparatus 10C has substantially the same functions as those of the projection apparatus 10A, but may be the same as or different from the projection apparatus 10A in configuration. For example, each of the projection apparatus 10B and the projection apparatus 10C has a configuration essential for a projection function, but may have a configuration that is not provided with at least one of an imaging device 12, an imaging controller 132, an image analyzer 133, a correction value calculator 134, an image acquisition unit 135, and a corrector 136 described later.

The projection apparatus 10A includes an optical device 11, the imaging device 12, a processing device 13, a storage device 14, and a communication device 15. These are coupled to each other with a single bus or a plurality of buses. Note that each element of the projection apparatus 10A is formed of a single device or a plurality of devices, but may be formed integrally with other elements.

The optical device 11 is a device that projects the projection image PI onto the projection surface SC under the control of the processing device 13. The optical device 11 includes, for example, a light source, a projection lens, dichroic mirrors, a prism, and liquid crystal panels, modulates light from the light source using the liquid crystal panels, which are examples of light modulation elements, and projects the modulated light onto the projection surface SC via the projection lens. The light modulation element may be a digital mirror device.

The imaging device 12 is a device that images the projection image PI projected on the projection surface SC under the control of the processing device 13. The imaging device 12 is, for example, an image sensor.

The processing device 13 is a processor that controls the entire projection apparatus 10A, and is configured with, for example, a single chip or a plurality of chips. The processing device 13 is configured with a central processing unit (CPU) including, for example, an interface with peripheral devices, an arithmetic operation device, and registers. Note that some or all of the functions of the processing device 13 may be implemented by hardware such as a digital signal processor (DSP), an application specific integrated circuit (ASIC), a programmable logic device (PLD), or a field programmable gate array (FPGA). The processing device 13 may include a system on chip (SoC). The processing device 13 executes various kinds of processing sequentially or in parallel.

The storage device 14 is a recording medium that the processing device 13 can read and stores a plurality of programs including a control program PR1 to be executed by the processing device 13. Further, the storage device 14 stores a pattern image which is used for measurement and is projected from the optical device 11 at the time of correction described later. The pattern image used for measurement is hereinafter referred to as measurement pattern in some cases. The storage device 14 may be configured with at least one of, for example, a read only memory (ROM), an erasable programmable ROM (EPROM), an electrically erasable programmable ROM (EEPROM), and a random access memory (RAM). The storage device 14 may be called a register, a cache, a main memory, a main storage device, or the like.

The communication device 15 is hardware serving as a transmission and reception device for performing communication with other apparatuses. The communication device 15 is also called, for example, a network device, a network controller, a network card, or a communication module. The communication device 15 may include a connector for wired connection and an interface circuit corresponding to the connector. Further, the communication device 15 may include a wireless communication interface. Examples of the connector for wired connection and the interface circuit include those conforming to one of the wired local area network (LAN), IEEE 1394, and the universal serial bus (USB). Further, examples of the wireless communication interface include those conforming to one of the wireless LAN, Bluetooth (registered trademark), and the like.

The processing device 13 functions as projection controller 131, the imaging controller 132, the image analyzer 133, the correction value calculator 134, the image acquisition unit 135, the corrector 136, and a communication controller 137 by reading the control program PR1 from the storage device 14 and executing the control program PR1. Note that the control program PR1 may be transmitted from, via a communication network, another apparatus such as a server that manages the projection apparatus 10A.

The projection controller 131 controls an operation of the optical device 11. More specifically, the projection controller 131 causes the optical device 11 to project the measurement pattern toward the projection surface SC. Further, the projection controller 131 causes the optical device 11 to project, toward the projection surface SC, an image acquired from the image supply apparatus 20 by the image acquisition unit 135 described later.

The imaging controller 132 controls an operation of the imaging device 12. More specifically, the imaging controller 132 causes the imaging device 12 to image the reflected light of the measurement pattern projected on the projection surface SC.

The image analyzer 133 analyzes a captured image captured by the imaging device 12. More specifically, the image analyzer 133 analyzes the captured image of the measurement pattern captured by the imaging device 12 to thereby calculate a measurement value representing a color (RGB value) and a brightness of the measurement pattern in the captured image.

The correction value calculator 134 calculates, based on the measurement value calculated by the image analyzer 133, a correction value to be set in the corrector 136 described later.

The image acquisition unit 135 acquires the image data from the image supply apparatus 20.

The corrector 136 corrects the image data using the correction value calculated by the correction value calculator 134. Specifically, the corrector 136 functions as a brightness correction circuit to thereby correct the brightness of the image acquired by the image acquisition unit 135 using the correction value calculated by the correction value calculator 134, and functions as a color unevenness correction circuit to thereby correct the color unevenness of the image acquired by the image acquisition unit 135 using the correction value calculated by the correction value calculator 134.

The communication controller 137 controls an operation of the communication device 15 to thereby cause the communication device 15 to transmit and receive various types of information to and from an external apparatus. More specifically, the communication controller 137 causes the communication device 15 to transmit the correction value from the projection apparatus 10A to each of the projection apparatus 10B and the projection apparatus 10C.

### 1-3: Correction of Chromaticity

In the related art, in the correction of chromaticity in a projection apparatus, a value set in advance or a value calculated from a measurement value in one projection apparatus out of a plurality of projection apparatuses is set as a target value, and all color tones (chromaticity) are corrected using the target value of the same color.

However, since black tint is different from tint of other color tones from a halftone to full white, when the target value in the correction of black is set to be the same as that of the other color tones, the black tint needs to be greatly changed from the original color, and therefore, it is necessary to ensure a large correction amount.

In addition, since the individual difference and the color unevenness in the projection image in black tint are large, when the target value is set in advance or determined from the measurement value in one projection apparatus, the difference between the original black tint and the target value increases, and in this regard as well, it is necessary to ensure a large correction amount.

As described above, in the black correction, it is necessary to ensure a large correction amount. Incidentally, in order to suppress a decrease in contrast after the correction, the correction amount of the black side color tone is set to be smaller than that of the white side color tone. Therefore, when the target color is set by the related-art method described above, there is a problem that the correction amount for black is insufficient and the chromaticity cannot be sufficiently corrected.

Therefore, the projection apparatus 10 calculates a target tint (chromaticity) for black color correction as follows.

Specifically, first, the projection apparatus 10 acquires a gradation characteristic at the black side. That gradation characteristic is a characteristic representing a relationship between an input gradation and an output luminance. Then, based on that gradation characteristic, the projection apparatus 10 estimates, as the target value of the brightness, the output luminance at the gradation expected to be corrected and determined in advance with respect to all the correction target points LP described later of all the projection apparatuses 10. The gradation expected to be corrected is determined by calibration, experiment, or the like. Subsequently, the projection apparatus 10 converts the estimated target value into u′ and v′ as examples of chromaticity. Then, the projection apparatus 10 sets the target chromaticity of black to the chromaticity at which the chromaticity difference between the plurality of correction target points LP is minimized based on the maximum values and the minimum values of u′ and v′ of all the correction target points LP. For example, the projection apparatus 10 sets, as the target chromaticity of black, an arithmetic average value of the maximum values and the minimum values of u′ and v′ of all the correction target points LP. Note that in the present embodiment, the chromaticity is defined by u′ and v′, but the type of chromaticity is not particularly limited. That is, the chromaticity may be defined by any one of u′v′ obtained by synthesizing u′ and v′, u and v, uv obtained by synthesizing u and v, x and y, and xy obtained by synthesizing x and y.

Here, in the estimation of the target value of the brightness, by determining the target value close to the chromaticity of the output luminance at the gradation expected to be corrected instead of the original black tint, there is an effect of suppressing the correction amount in the correction of the chromaticity. Further, by targeting the color of the gradation higher than black, the chromaticity of black after the correction can be made close to the chromaticity of halftone.

In addition, in the setting of the target chromaticity of black, by setting the value based on the maximum value and the minimum value of u′ and v′ of all the correction target points LP as the target chromaticity of black, it is possible to reduce the chromaticity difference after the correction when the correction amount is insufficient at the time of the chromaticity correction. In addition, it is possible to reduce the possibility that the correction amount of black is insufficient.

In the description citing a specific example, for example, when the number of projection apparatuses 10 is ten, and the chromaticity of black in nine projection apparatuses 10 out of the ten projection apparatuses 10 is the same at (u′, v′)=(0.200, 0.400), whereas the chromaticity of black in the remaining one projection apparatus 10 is (u′, v′)=(0.230, 0.430), the chromaticity difference before the correction is (Δu′, Δv′)=(0.030, 0.030). Meanwhile, the correctable chromaticity range of black is, for example, about (Δu′, Δv′)=(0.010, 0.010). The correctable chromaticity range of black can vary in value depending on the performance of the projection apparatus 10, the color of black to be realized, the contrast ratio, and so on.

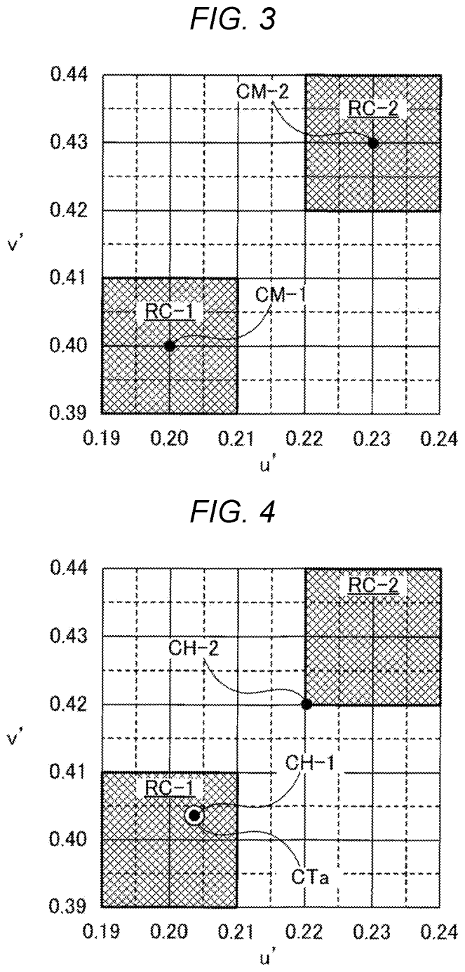

FIG. 3 is a diagram illustrating the correctable chromaticity range between the projection apparatuses 10. In FIG. 3, the horizontal axis represents the u′ value, and the vertical axis represents the v′ value. In FIG. 3, the chromaticity of black in the nine projection apparatuses 10 out of the ten projection apparatuses 10 described above is represented as chromaticity CM-1, and the chromaticity of black in the remaining one projection apparatus 10 is represented as chromaticity CM-2. Further, in FIG. 3, the correctable chromaticity range of black of the nine projection apparatuses out of the ten projection apparatuses 10 is displayed with shading as a range RC-1 centered on the chromaticity CM-1, and the correctable chromaticity range of black in the remaining one projection apparatus 10 is displayed with shading as a range RC-2 centered on the chromaticity CM-2. Note that each of the ranges RC-1 and RC-2 has a square shape in FIG. 3 for the sake of convenience of description, but may actually have various shapes.

The correctable chromaticity range can be expanded by increasing the gradation that can be selected as the correction value. However, in the correction of black, when the number of gradations that can be selected as the correction value is increased too much, black after the connection becomes too bright. Therefore, the correctable chromaticity range is limited to the extent described above. It should be noted that the correctable chromaticity range described above is illustrative only, and in reality, the correctable chromaticity range differs for each projection apparatus 10 or for each correction target point LP.

FIG. 4 is a diagram illustrating the chromaticity correction when an average value of the chromaticity of the plurality of projection apparatuses 10 is set as the target value CTa of the chromaticity. In this case, the average value of the chromaticity of black of the ten projection apparatuses 10 described above is (u′, v′)=(0.203, 0.403). Therefore, the target value CTa in the chromaticity correction of the ten projection apparatuses 10 described above is located within the range RC-1 but is located outside the range RC-2. Therefore, when the chromaticity of each projection apparatus 10 is corrected to the target value CTa, the chromaticity in the nine projection apparatuses 10 can be corrected to the target value CTa, but the correction limit is reached in the remaining one projection apparatus 10. That is, the chromaticity after the correction in the nine projection apparatuses 10 is (u′, v′)=(0.203, 0.403), but the chromaticity after the correction in the remaining one projection apparatus 10 is (u′, v′)=(0.220, 0.420). Therefore, the chromaticity difference after the correction in the remaining one projection apparatus 10 is (Δu′, Δν′)=(0.017, 0.017).

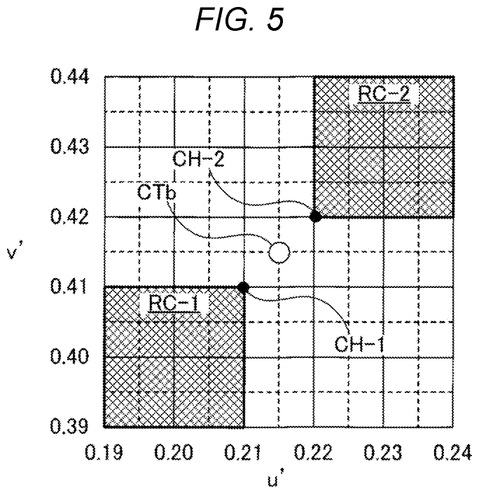

FIG. 5 is a diagram illustrating the chromaticity correction when the arithmetic average value of the maximum value and the minimum value f the chromaticity in the plurality of projection apparatuses 10 is set as the target value CTb of the chromaticity. In this case, the target value CTb in the chromaticity correction of the ten projection apparatuses 10 described above becomes (u′, v′)=(0.215, 0.415). Therefore, when the chromaticity in each projection apparatus 10 is corrected into the target value CTa, the correction limit is reached in all the ten projection apparatuses 10, but the chromaticity after the correction in the nine projection apparatuses 10 is (u′, v′)=(0.210, 0.410), and the chromaticity after the correction of the remaining one projection apparatus 10 becomes (u′, v′)=(0.220, 0.420). Therefore, in any of the projection apparatuses 10 as well, the chromaticity difference after the correction is (Δu′, Δv′)=(0.010, 0.010), which is smaller than the case shown in FIG. 4 described above.

Note that the above correction of black has been described taking the problem of the chromaticity difference between the plurality of projection apparatuses 10 as an example, but the problem of the chromaticity difference between the plurality of correction target points LP in one projection apparatus 10 can also be solved in a similar manner.

### 1-4: Control Method

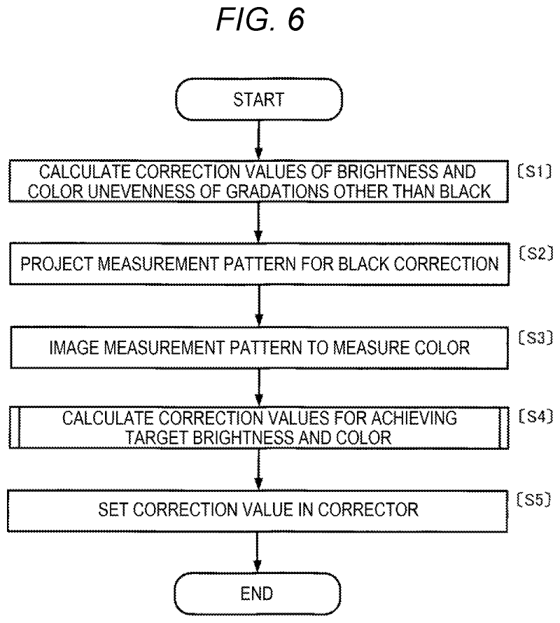

FIG. 6 is a flowchart showing a control method according to the embodiment. As shown in FIG. 6, the control method includes steps S1 to S5. First, the outline of each step will hereinafter be described based on FIG. 6. Note that since steps S1 to S5 are similarly applied to the projection apparatuses other than the projection apparatus 10A, the operation of the projection apparatus 10A will be mentioned below unless there is a particular difference.

First, in step S1, the projection apparatus 10A calculates each of a brightness correction value and a color unevenness correction value for the gradations other than black. Further, in step S1, the projection apparatus 10A uses those correction values to adjust the brightness and the color of the projection image PI from the projection apparatuses 10A, 10B, and 10C so as to be homogenous among the projection apparatuses 10.

After step S1, in step S2, the projection apparatus 10A projects the measurement pattern for correcting black onto the projection surface SC. Specifically, the processing device 13 which functions as the projection controller 131 reads the measurement patterns from the storage device 14 and causes the optical device 11 to sequentially project the plurality of measurement patterns onto the projection surface SC.

After step S2, in step S3, the processing device 13 which functions as the imaging controller 132 of the projection apparatus 10A causes the imaging device 12 to image each measurement pattern projected on the projection surface SC. Further, the processing device 13 which functions as the image analyzer 133 of the projection apparatus 10A analyzes the measurement pattern imaged by the imaging device 12, and calculates the measurement value representing the color (RGB value) and the brightness of the measurement pattern in the captured image. Note that the number of times of execution of step S2 and step S3 can be appropriately changed in accordance with the number of measurement patterns. In the present embodiment, step S2 and step S3 are executed a plurality of times.

After step S3, in step S4, the processing device 13 which functions as the correction value calculator 134 of the projection apparatus 10A calculates the correction values of the brightness and the color unevenness of black.

After step S4, in step S5, the processing device 13 which functions as the correction value calculator 134 of the projection apparatus 10A sets the correction values calculated in step S4 as the setting values.

Due to steps S1 to S5 described above, the brightness and color unevenness of black can be corrected. Each step will hereinafter be described in detail.

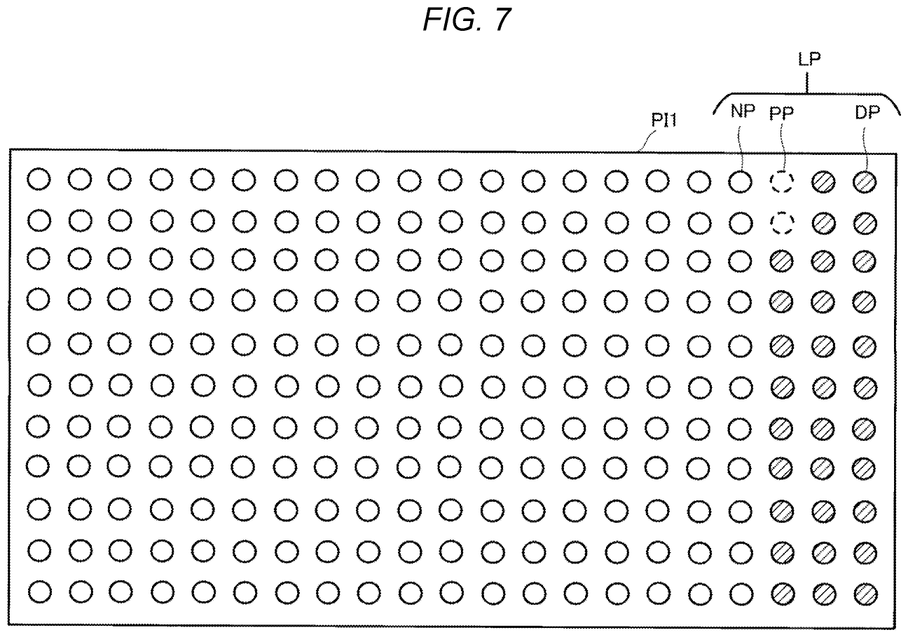

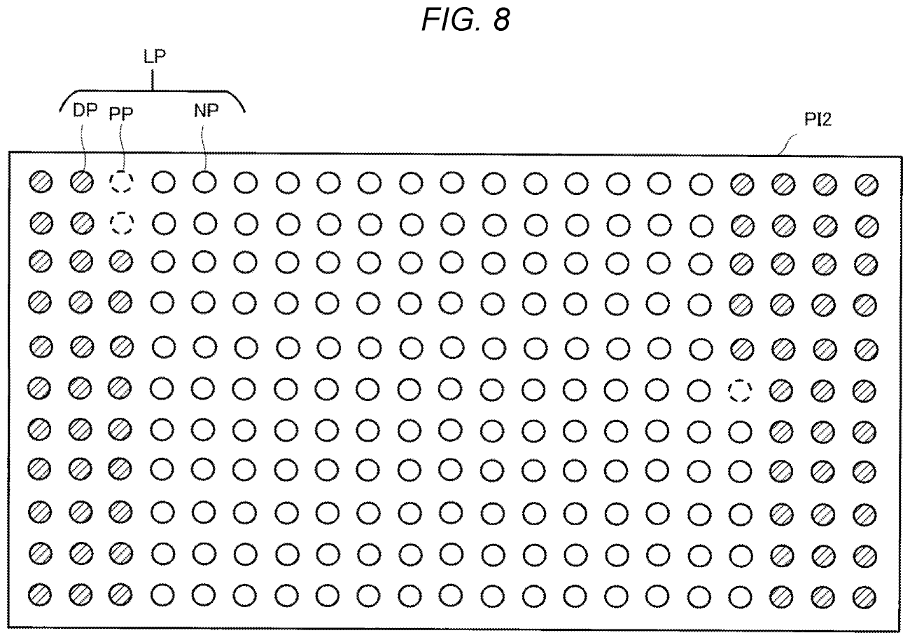

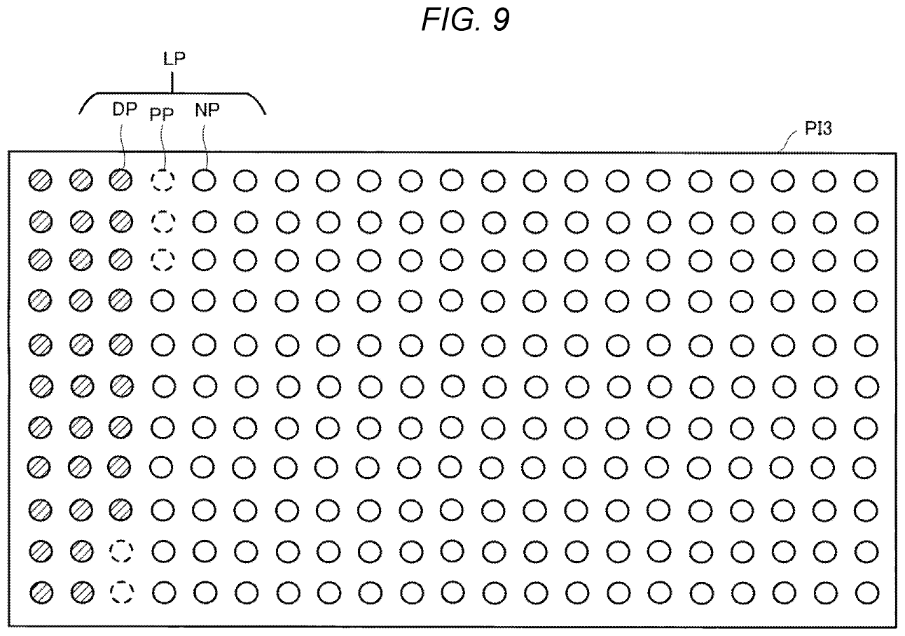

FIGS. 7 to 9 are diagrams illustrating an example of the plurality of correction target points LP. FIG. 7 shows an example of the correction target point LP corresponding to the projection image PI1 projected from the projection apparatus 10A. FIG. 8 shows an example of the correction target point LP corresponding to the projection image PI2 projected from the projection apparatus 10B. FIG. 9 shows an example of the correction target point LP corresponding to the projection image PI3 projected from the projection apparatus 10C.

The correction target point LP is a point corresponding to a pixel to be subjected to color unevenness correction out of the plurality of pixels of the projection image PI. In FIGS. 7 to 9, the plurality of correction target points LP corresponding to grid points in a 11×21 matrix is illustrated.

As shown in FIGS. 7 to 9, the plurality of correction target points LP are divided into a plurality of correction target points DP, a plurality of correction target points NP, and a plurality of correction target points PP. The correction target point DP is the correction target point LP corresponding to a pixel belonging to the overlapping area DR, and is indicated by a hatched circle in the drawing. The correction target point NP is the correction target point LP corresponding to a pixel belonging to the non-overlapping area NR, and is indicated by a white circle in the drawing. The correction target point PP is the correction target point LP on which the determination on whether the pixel corresponding to the correction target point belongs to the overlapping area DR or the non-overlapping area NR has fail to be made, and is indicated by a dashed circle in the drawing.

There is a measurement value calculated by the image analyzer 133 for each of such a plurality of correction target points LP as described above.

The brightness correction in step S1 is the correction of reducing, for the gradations other than black, the difference between the brightness of the overlapping area DR and the brightness of the non-overlapping area NR. The method used for the brightness correction is not particularly limited, and may be various known methods such as a method of correcting the brightness and the color unevenness by setting, as a target area, any of the areas RL1 to RL5 shown in FIG. 1, and comparing an imaging value obtained by imaging that target area with an imaging value obtained by imaging another area.

Incidentally, the color unevenness correction in step S1 is performed, for example, for each of the correction target points LP in the 11×21 matrix described above. That correction is performed based on, for example, gradations on boundaries obtained by dividing the gradation width in 10 bits, that is, the gradation width from a gradation 0 to a gradation 1023 into eight equal parts.

Note that in the processing in step S1, the processing device 13 determines whether each of the correction target points LP belongs to the overlapping area DR or the non-overlapping area NR. For example, prior to step S1, the processing device 13 projects a full white image as a projection image only from the optical device 11 and captures that full white image with the imaging device 12 of the projection apparatus 10A. Subsequently, a full white image is projected only from the projection apparatus 10B as a projection image and that full white image is captured with the imaging device 12 of the projection apparatus 10A. Then, the processing device 13 detects, from these imaging results, a position of a right side of the full white image projected from the projection apparatus 10A and a position of a left side of the full white image projected from the projection apparatus 10B, and then determines that an area from the position of the right side to the position of the left side is the overlapping area DR in a coordinate system of the captured image. Further, based on a correspondence relationship among a coordinate system of the projection apparatus 10A, a coordinate system of the projection apparatus 10B, and the coordinate system of the captured image generated prior to step S1, the processing device 13 converts the overlapping area DR in the coordinate system of the captured image into the overlapping area DR in the coordinate system of the projection apparatus 10A and the overlapping area DR in the coordinate system of the projection apparatus 10B. Further, the processing device 13 determines whether each of the correction target points LP belongs to the overlapping area DR in the coordinate system of the projection apparatus 10A and the overlapping area DR in the coordinate system of the projection apparatus 10B based on the captured image of the correction target point LP. That correspondence relationship can be calculated by, for example, a well-known calibration technique using a gray code. The coordinate system of the projection apparatus 10A is a two-dimensional coordinate system of the liquid crystal panel. In this regard, the same applies to the coordinate system of the projection apparatus 10B. Further, the determination method described above is the same with respect to the projection apparatus 10B and the projection apparatus 10C.

Note that such a method of determining whether each of the correction target points LP belongs to the overlapping area DR or the non-overlapping area NR as described above is illustrative only, and can be changed as appropriate.

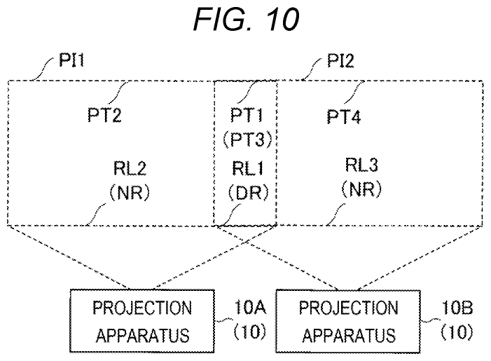

FIG. 10 is a diagram illustrating projection of the measurement pattern by the projection apparatuses 10A, 10B. Note that in FIG. 10, for the sake of convenience of description, only the projection image PI1 projected from the projection apparatus 10A and the projection image PI2 projected from the projection apparatus 10B are shown, and the projection image PI3 projected from the projection apparatus 10C is omitted from the illustration. Hereinafter, a case of the measurement pattern is projected as the projection images PI1, PI2 will be representatively described.

The measurement pattern used in step S2 is an image for acquiring the relationship between the input gradation and the output luminance, and is, for example, an image in at least four gradations. Note that the measurement pattern used in step S2 may be an image of the gradation 0.

In order to increase the luminance of the measurement pattern, it is preferable that the measurement pattern is provided with a color obtained by changing one of color components of an R component, a G component, and a B component based on gray as a reference instead of a single color of only one of the R component, the G component, and the B component. In this case, gray as a reference is preferably gray in which all of the R component, the G component, and the B component become the gradation close to the output gradation after the color unevenness correction in the overlapping area DR. As a result, the following ten patterns are used as the gradation of the measurement pattern. Note that, for the sake of convenience of description, the values of the R component, the G component, and the B component in the measurement patterns (1) to (10) are hereinafter described as (r, g, b). In addition, A, B, C, and D are gradations different from each other, and are in the order of A, B, C, and D from the smallest to the largest. For example, a gradation (A) is a gradation (22), a gradation (B) is a gradation (34), a gradation (C) is a gradation (60), and a gradation (D) is a gradation (95).

$$Measurement pattern ( 1 ) : ( r , g , b ) = ( D , B , B )$$

$$Measurement pattern ( 2 ) : ( r , g , b ) = ( B , D , B )$$

$$Measurement pattern ( 3 ) : ( r , g , b ) = ( B , B , D )$$

$$Measurement pattern ( 4 ) : ( r , g , b ) = ( C , B , B )$$

$$Measurement pattern ( 5 ) : ( r , g , b ) = ( B , C , B )$$

$$Measurement pattern ( 6 ) : ( r , g , b ) = ( B , B , C )$$

$$Measurement pattern ( 7 ) : ( r , g , b ) = ( B , B , B )$$

$$Measurement pattern ( 8 ) : ( r , g , b ) = ( A , B , B )$$

$$Measurement pattern ( 9 ) : ( r , g , b ) = ( B , A , B )$$

$$Measurement pattern ( 10 ) : ( r , g , b ) = ( B , B , A )$$

When the measurement pattern includes the gradation 0, it is preferable to further use the following measurement patterns.

$$Measurement pattern ( 11 ) : ( r , g , b ) = ( 0 , B , B )$$

$$Measurement pattern ( 12 ) : ( r , g , b ) = ( B , 0 , B )$$

$$Measurement pattern ( 13 ) : ( r , g , b ) = ( B , B , 0 )$$

By using the measurement patterns described above, it is possible to make the measurement pattern projected brighter, improve an S/N ratio of the imaging device 12, and reduce an error of the measurement value.

In step S2, the projection image PI1 projected by the projection apparatus 10A and the projection image PI2 projected by the projection apparatus 10B are the same measurement pattern. Further, in step S2, the projection of the projection image PI1 by the projection apparatus 10A and the projection of the projection image PI2 by the projection apparatus 10B are synchronized with each other. That is, the projection image PI2 is projected onto the projection surface SC at the same timing as that of the projection image PI1.

By projecting the measurement patterns as described above, the S/N ratio of the imaging device 12 is improved by making the brightness of the overlapping area DR twice or more compared to the aspect in which the measurement pattern is projected by one projection apparatus 10. As a result, the projection apparatus 10A according to the present embodiment can prevent the error of the measurement value calculated by the image analyzer 133. In addition, in each measurement pattern, since the gradations of at least two of the R component, the G component, and the B component are not 0, it is possible to reduce the error of the measurement value using the imaging device 12.

In step S3, after the processing device 13 which functions as the imaging controller 132 causes the imaging device 12 to image each measurement pattern projected on the projection surface SC, the processing device 13 which functions as the image analyzer 133 analyzes the captured image obtained by the imaging device 12 imaging the measurement pattern to thereby calculate the measurement values representing the color (RGB value) and the brightness of the measurement pattern in that captured image.

In this analysis, first, the processing device 13 obtains the correspondence relationship between the gradation values (r, g, b) (0≤r, g, b≤95) of the colored light as the measurement pattern projected by the optical device 11 and the measurement values (R, G, B) representing the color of the colored light in the captured image calculated by analyzing the colored light as the measurement pattern imaged by the imaging device 12 at each of the correction target points LP by an interpolation operation.

Here, the measurement data include brightness values representing the brightness of the reflected light of the colored light corresponding to the R component, the G component, and the B component.

Hereinafter, in order to make the notation easy to understand, the R component, the G component, and the B component of the measurement values (R, G, B) representing the color of the colored light in the captured image calculated by the processing device 13 when the colored light of the gradation values (r, g, b) is projected as the measurement pattern by the optical device 11 are denoted by R_{(r, g, b)}, G_{(r, g, b)}, and B_{(r, g, b)}, respectively.

Further, when the R component, the G component, and the B component of the measurement value representing the color of the colored light in the captured image are collectively expressed, the components are denoted as (R, G, B)_{(r, g, b)}=(R_{(r, g, b)}, G_{(r, g, b)}, B_{(r, g, b)}).

The measurement values of the five measurement patterns in which only the R component is changed in the gradation values (r, g, b) of the colored light as the measurement patterns are expressed by the following Formulas 1 to 5.

$${( R , G , B )}_{( 0 , 34 , 34 )} = ( {R}_{( 0 , 34 , 34 )} , {G}_{( 0 , 34 , 34 )} , {B}_{( 0 , 34 , 34 )} ) \qquad [ 1 ]$$

$${( R , G , B )}_{( 22 , 34 , 34 )} = ( {R}_{( 22 , 34 , 34 )} , {G}_{( 22 , 34 , 34 )} , {B}_{( 22 , 34 , 34 )} ) \qquad [ 2 ]$$

$${( R , G , B )}_{( 34 , 34 , 34 )} = ( {R}_{( 34 , 34 , 34 )} , {G}_{( 34 , 34 , 34 )} , {B}_{( 34 , 34 , 34 )} ) \qquad [ 3 ]$$

$${( R , G , B )}_{( 60 , 34 , 34 )} = ( {R}_{( 60 , 34 , 34 )} , {G}_{( 60 , 34 , 34 )} , {B}_{( 60 , 34 , 34 )} ) \qquad [ 4 ]$$

$${( R , G , B )}_{( 95 , 34 , 34 )} = ( {R}_{( 95 , 34 , 34 )} , {G}_{( 95 , 34 , 34 )} , {B}_{( 95 , 34 , 34 )} ) \qquad [ 5 ]$$

The measurement values of these five measurement patterns are all known. Therefore, the processing device 13 can perform curve interpolation between the measurement values of the R component out of these measurement values (R, G, B). The same applies to the G component and the B component. As the curve interpolation method, a known method can be used. For example, the processing device 13 may perform the curve interpolation using a spline curve. Alternatively, the processing device 13 may perform parabolic interpolation using three points out of five points corresponding to the five measurement values. Alternatively, the processing device 13 may execute cubic curve interpolation using four points out of the five points corresponding to the five measurement values. An example of the cubic curve interpolation is cubic interpolation.

When only the R component r out of the gradation values (r, g, b) of the colored light as the measurement pattern is changed, an interpolation curve R (r, 34, 34) for interpolating the measurement value of the R component, an interpolation curve G (r, 34, 34) for interpolating the measurement value of the G component, and an interpolation curve B (r, 34, 34) for interpolating the measurement value of the B component out of the measurement values (R, G, B) calculated by the processing device 13 are obtained.

In step S3, the processing device 13 uses the three interpolation curves R (r, 34, 34), G (r, 34, 34), and B (r, 34, 34) to thereby estimate the measurement value (R, G, B)_{(r, 34, 34)}=(R_{(r, 34, 34)}, G_{(r, 34, 34)}, B_{(r, 34, 34)}) when the colored light the R component of which has any gradation r (0≤r≤95) is projected onto the projection surface SC.

When only the G component g out of the gradation values (r, g, b) of the colored light as the measurement pattern is changed, an interpolation curve R (34, g, 34) for interpolating the measurement value of the R component, an interpolation curve G (34, g, 34) for interpolating the measurement value of the G component, and an interpolation curve B (34, g, 34) for interpolating the measurement value of the B component out of the measurement values (R, G, B) calculated by the processing device 13 are obtained.

In step S3, the processing device 13 uses the three interpolation curves R (34, g, 34), G (34, g, 34), and B (34, g, 34) to thereby estimate the measurement value (R, G, B) (34, g, 34)=(R (34, g, 34), G (34, g, 34), B (34, g, 34)) when the colored light the G component of which has any gradation g (0≤g≤95) is projected onto the projection surface SC.

When only the B component b out of the gradation values (r, g, b) of the colored light as the measurement pattern is changed, an interpolation curve R (34, 34, b) for interpolating the measurement value of the R component, an interpolation curve G (34, 34, b) for interpolating the measurement value of the G component, and an interpolation curve B (34, 34, b) for interpolating the measurement value of the B component out of the measurement values (R, G, B) calculated by the processing device 13 are obtained.

In step S3, the processing device 13 uses the three interpolation curves R (34, 34, b), G (34, 34, b), and B (34, 34, b) to thereby estimate the measurement value (R, G, B)_{(34, 34, b)}=(R_{(34, 34, b)}, G_{(34, 34, b)}, B_{(34, 34, b)}) when the colored light the B component of which has any gradation b (0≤b≤95) is projected onto the projection surface SC.

As illustrated in the following Formulas 6 to 8 using the functions of the interpolation curves R (r, 34, 34), G (r, 34, 34), B (r, 34, 34), R (34, g, 34), G (34, g, 34), B (34, g, 34), R (34, 34, b), G (34, 34, b), and B (34, 34, b) described above, it becomes possible to estimate the measurement value (R, G, B)_{(r, g, b)}=(R_{(r, g, b)}, G_{(r, g, b)}, B_{(r, g, b)}) when only one color component of the gradation values (r, g, b) of the colored light projected from the optical device 11 is changed and the other color components are fixed to the gradation 34.

$${( R , G , B )}_{( r , 34 , 34 )} = ( {R}_{( r , 34 , 34 )} , {G}_{( r , 34 , 34 )} , {B}_{( r , 34 , 34 )} ) \qquad [ 6 ]$$

$${( R , G , B )}_{( 34 , g , 34 )} = ( {R}_{( 34 , g , 34 )} , {G}_{( 34 , g , 34 )} , {B}_{( 34 , g , 34 )} ) \qquad [ 7 ]$$

$${( R , G , B )}_{( 34 , 34 , b )} = ( {R}_{( 34 , 34 , b )} , {G}_{( 34 , 34 , b )} , {B}_{( 34 , 34 , b )} ) \qquad [ 8 ]$$

In Formulas 6 to 8 described above, out of the gradation values (r, g, b) of the colored light projected from the optical device 11, only one of the R component r, the G component g, and the B component b is freely changed, and the other two components are fixed to the gradation 34. Therefore, by applying the property of the additive color mixture to Formulas 6 to 8, it becomes possible for the processing device 13 to estimate the measurement value (R, G, B)_{(r, g, b)}=(R_{(r, g, b)}, G_{(r, g, b)}, B_{(r, g, b)}) when all of the R component r, the G component g, and the B component b out of the gradation values (r, g, b) (0≤r, g, b≤95) of the colored light are freely changed by using following Formula 9.

$$[ 9 ]$$

$${( R , G , B )}_{( r , g , b )} = {( R , G , B )}_{( r , 34 , 34 )} + {( R , G , B )}_{( 34 , g , 34 )} + {( R , G , B )}_{( 34 , 34 , b )} - 2 \times {( R , G , B )}_{( 34 , 34 , 34 )}$$

Note that in Formula 9, an origin of the additive color mixture is not (r, g, b)=(0, 0, 0) but is (r, g, b)=(34, 34, 34). When Formula 9 is expressed for each component, the following Formulas 10 to 12 are obtained.

$${R}_{( r , g , b )} = {R}_{( r , 34 , 34 )} + {R}_{( 34 , g , 34 )} + {R}_{( 34 , 34 , b )} - 2 \times {R}_{( 34 , 34 , 34 )} \qquad [ 10 ]$$

$${G}_{( r , g , b )} = {G}_{( r , 34 , 34 )} + {G}_{( 34 , g , 34 )} + {G}_{( 34 , 34 , b )} - 2 \times {G}_{( 34 , 34 , 34 )} \qquad [ 11 ]$$

$${B}_{( r , g , b )} = {B}_{( r , 34 , 34 )} + {B}_{( 34 , g , 34 )} + {B}_{( 34 , 34 , b )} - 2 \times {B}_{( 34 , 34 , 34 )} \qquad [ 12 ]$$

The image analyzer 133 converts the RGB values into XYZ values by using Formula 13 in which a matrix having elements R_{(r, g, b)}, G_{(r, g, b)}, and B_{(r, g, b)}, which are the RGB values calculated by Formulas 10 to 12, is multiplied by a transformation matrix M specific to the imaging device 12. As a result, the image analyzer 133 can estimate output values XYZ for any gradation. The transformation matrix M is a matrix for transforming the RGB values and the output values XYZ to each other, and is determined by performing well-known calibration on the imaging device 12 in advance.

$${( \begin{matrix}X \\ Y \\ Z\end{matrix} )}_{( r , g , b )} = ( \begin{matrix}{X}_{( r , g , b )} \\ {Y}_{( r , g , b )} \\ {Z}_{( r , g , b )}\end{matrix} ) = M \times ( \begin{matrix}{R}_{( r , g , b )} \\ {G}_{( r , g , b )} \\ {B}_{( r , g , b )}\end{matrix} ) \qquad [ 13 ]$$

Further, the image analyzer 133 converts the estimated XYZ values into u′ and v′ by using Formula 14 described below.

$${u}^{′} = \frac{4 X}{X + 15 Y + 3 Z} , {v}^{′} = \frac{9 Y}{X + 15 Y + 3 Z} \qquad [ 14 )$$

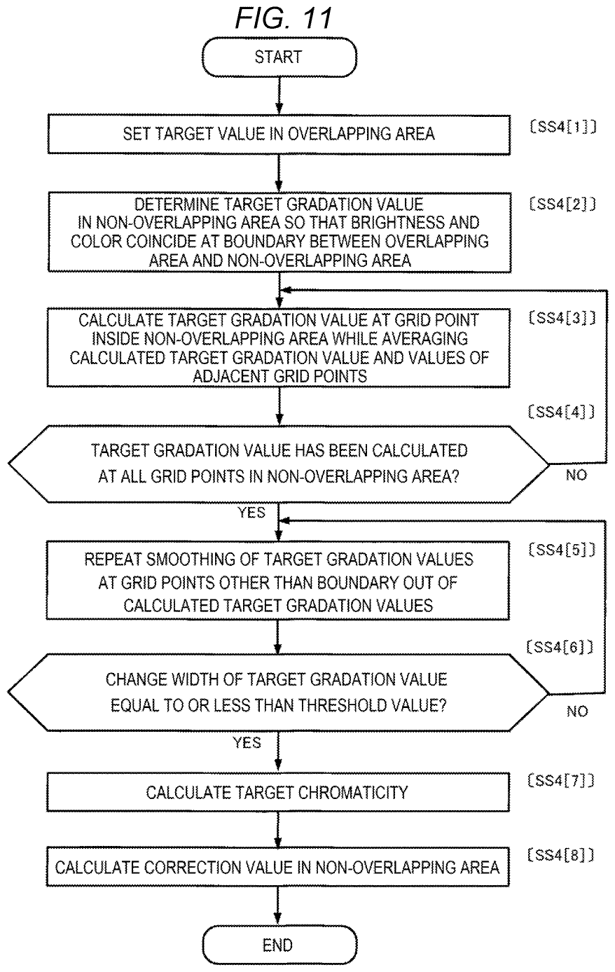

FIG. 11 is a flowchart illustrating the calculation of the correction value in step S4. As shown in FIG. 11, step S4 includes steps SS4[1] to SS4[8].

More specifically, first, in step SS4[1], the processing device 13 which functions as the correction value calculator 134 sets the target value of the brightness at the correction target point DP belonging to the overlapping area DR on the assumption that the target brightness in the overlapping area DR has already been determined by a known method, a calibration, or an experiment.

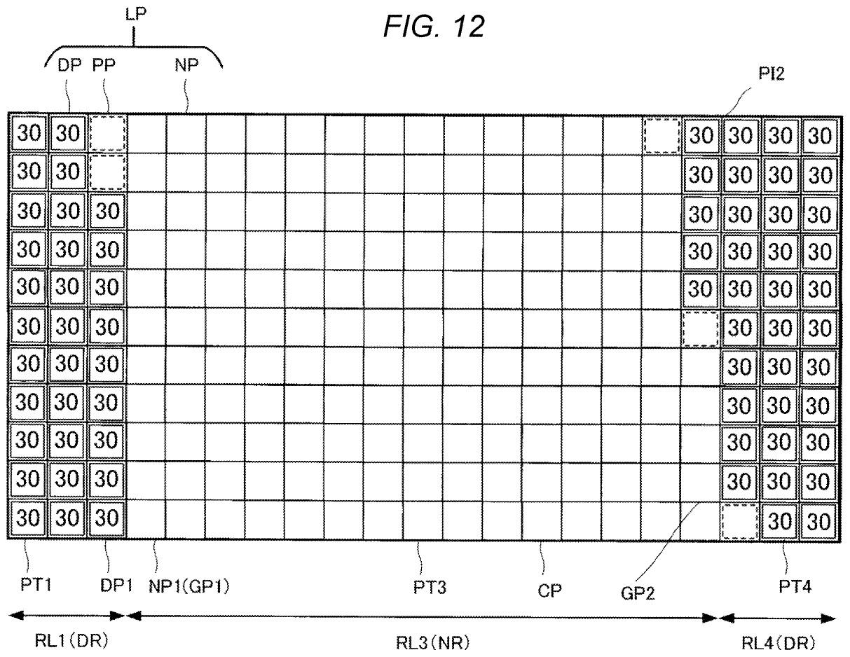

FIG. 12 is a diagram illustrating an example of the target value of the brightness at the correction target point DP, which is the correction target point LP in the overlapping area DR. FIG. 12 shows an example of a target gradation value (r, g, b) as the target value of the brightness at the correction target point DP. In other words, by setting the gradation value at the correction target point DP to the target gradation value (r, g, b), the brightness at the correction target point DP becomes the target value of the brightness. Furthermore, by setting the gradation value of at least one pixel corresponding to the correction target point DP out of the plurality of pixels of the liquid crystal panel to the target gradation value (r, g, b), the brightness at the correction target point DP becomes the target value of the brightness. In the present embodiment, the target gradation value (r, g, b) is about (30, 30, 30). However, the specific value of the target gradation value (r, g, b) is appropriately changed according to the target value of the brightness at the correction target point DP. FIG. 12 shows an example of the value of one of the r component, the g component, and the b component contained in the gradation value (r, g, b) for each correction target point DP in the projection image PI2. Each numerical value in the drawings is an integer for convenience, but may be a decimal.

In FIG. 12, the plurality of correction target points LP are shown as a plurality of rectangular cells. In FIG. 12, a cell indicated by a frame line formed by a solid double line corresponds to the correction target point DP which is the correction target point LP belonging to the overlapping area DR. In FIG. 12, a cell indicated as a frame line formed by a solid single line corresponds to the correction target point NP which is the correction target point LP belonging to the non-overlapping area NR. In FIG. 12, a cell indicated as a frame line formed by a double line of a solid line and a broken line corresponds to the correction target point PP which is the correction target point LP that cannot be determined to belong to the overlapping area DR or to belong to the non-overlapping area NR.

In step SS4[2] of FIG. 11, the processing device 13 which functions as the correction value calculator 134 determines the target gradation value (r, g, b) at the correction target point NP so that at least the brightness is uniform between the correction target point DP belonging to the overlapping area DR and the correction target point NP belonging to the non-overlapping area NR, which are adjacent to each other across the boundary between the overlapping area DR and the non-overlapping area NR.

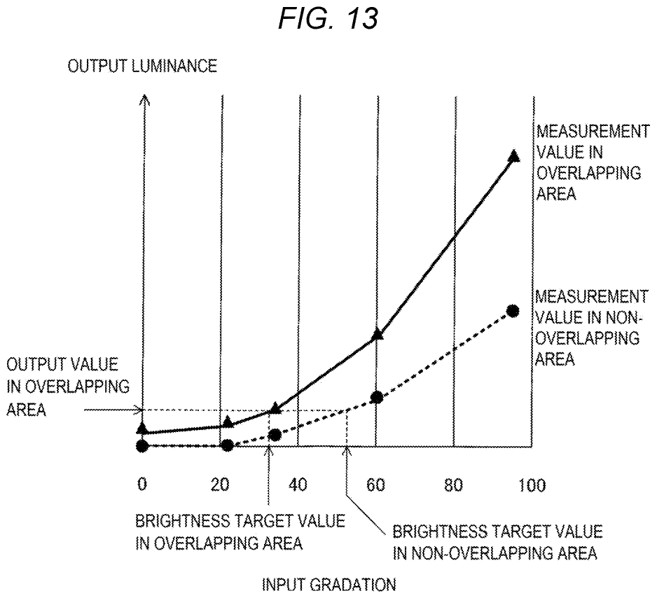

FIG. 13 is a diagram illustrating a relationship between the input gradation and the output luminance in the overlapping area DR and the non-overlapping area NR. In step S3 described above, such gradation characteristics at the black side as illustrated in FIG. 13 are acquired. FIG. 13 shows the relationship between the input gradation and the output luminance at the correction target point DP and the correction target point NP adjacent to each other. In FIG. 13, “MEASUREMENT VALUE IN OVERLAPPING AREA” represents the relationship between the input gradation and the output luminance at: the correction target point DP, and “MEASUREMENT VALUE IN NON-OVERLAPPING AREA” represents the relationship between the input gradation and the output luminance at the correction target point NP.

In order to calculate the target value of the brightness of the correction target point NP adjacent to the correction target point DP, first, the processing device 13 calculates the luminance as the output value when the gradation value as the target value of the brightness is input in the correction target point DP. Then, the processing device 13 calculates the input value of the correction target point NP such that the output value is the same as the calculated output value, and sets the calculated input value as the target value of the brightness at the correction target point NP.

Thus, the target gradation value (r, g, b) at the correction target point NP is calculated based on the target gradation value (r, g, b) at the correction target point DP. Hereinafter, a specific calculation method will be described.

In step SS4[2], the processing device 13 estimates the RGB value as the measurement value by the imaging device 12 by applying Formulas 10 to 12 described above to the gradation value (r, g, b) having already been calculated. Further, the processing device 13 converts the RGB values as the measurement values into the XYZ values by applying Formula 13 described above to the estimated measurement values (R, G, B) (r, g, b). Further, the processing device 13 further converts the converted XYZ values into u′ and v′ by applying Formula 14 described above to the converted XYZ values.

In this way, u′ and v′ at the correction target point DP1 are calculated. Then, the processing device 13 sets those u′ and v′ to u′ and v′ as the target values at the correction target point NP1. Further, the processing device 13 calculates the target gradation value (r, g, b) at the correction target point NP1 by performing a back calculation on u′ and v′ as the target values using Formulas 6 to 14 described above.

When the brightness at the correction target point NP1 is the target value, the processing device 13 calculates, as a target gradation value (r, g, b) at the correction target point NP, the gradation value t with which the r component, the g component, and the b component become (r, g, b)=(t, t, t). Specifically, the processing device 13 calculates the gradation value t with which the correction target point DP1 and the correction target point NP1 have the same brightness when the gray colored light is projected from the optical device 11.

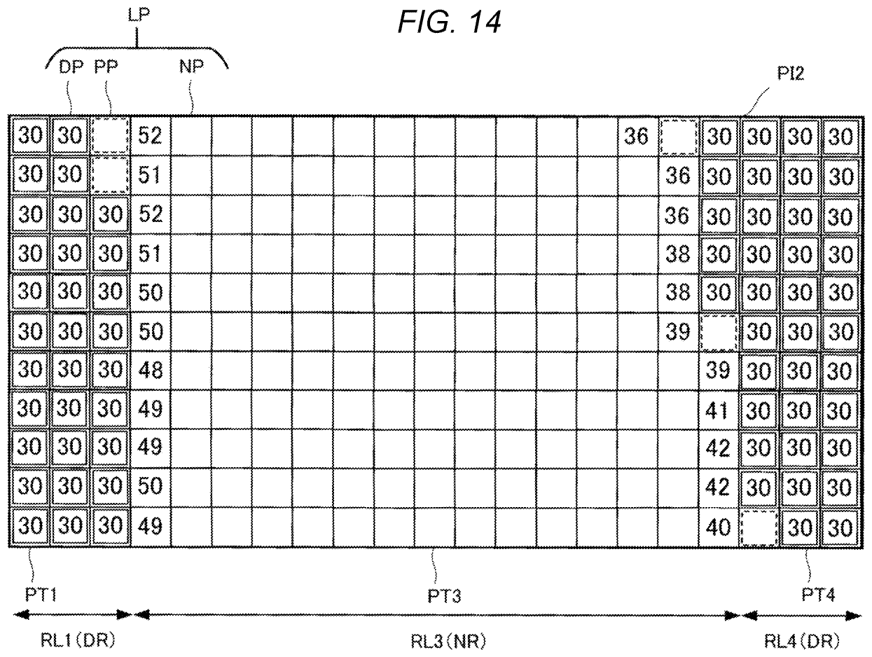

FIG. 14 is a diagram illustrating an example of the target value of the brightness at the correction target point NP adjacent to the overlapping area DR out of the correction target points NP in the non-overlapping area NR. That target value is the target gradation value t.

In FIG. 14, the target gradation value t at the correction target point NP is larger than the target gradation value (r, g, b) at the correction target point DP. This is because the brightness at the correction target point DP is substantially twice as high as the brightness at the correction target point NP, and thus it is necessary to increase the target gradation value t at the correction target point NP in the non-overlapping area NR in order to substantially equalize the brightness at the correction target point DP and the brightness at the correction target point NP.

When the correction is not performed, since the non-overlapping area NR is darker than the overlapping area DR, in order to make a brightness component Y the same in the overlapping area DR and the non-overlapping area NR after the correction, it is necessary to make the target gradation value t at the correction target point NP larger than the target gradation value (r, g, b) at the correction target point DP.

In step SS4[3] in FIG. 11, the processing device 13 calculates the target gradation value t of a further correction target point NP by averaging the target gradation value t of the correction target point NP calculated in step SS4[2] and the target gradation value t of the adjacent correction target point NP.

Specifically, when the target gradation value t has been determined at one or more of the correction target points NP adjacent upward, downward, leftward, and rightward to the correction target point NP at which the target gradation value t has not been determined, the processing device 13 calculates an average value of the target gradation values t of these correction target points NP. The processing device 13 sets the calculated average value as the target gradation value t at the correction target point NP at which the target gradation value t has not been determined.

In step SS4[4] in FIG. 11, the processing device 13 which functions as the correction value calculator 134 determines whether the target gradation value t has been calculated at all the correction target points NP in the non-overlapping area NR. When the target gradation value t has been calculated at all the correction target points NP in the non-overlapping area NR (“YES” in step SS4[4]), the processing device 13 executes processing in step SS4[5]. On the other hand, when the target gradation value t has not been calculated at all the correction target points NP in the non-overlapping area NR (“NO” in step SS4[4]), the processing device 13 executes processing in step SS4[3].

In this way, the processing device 13 sequentially extends the correction target point NP at which the target gradation value t is calculated to the inside of the non-overlapping area NR.

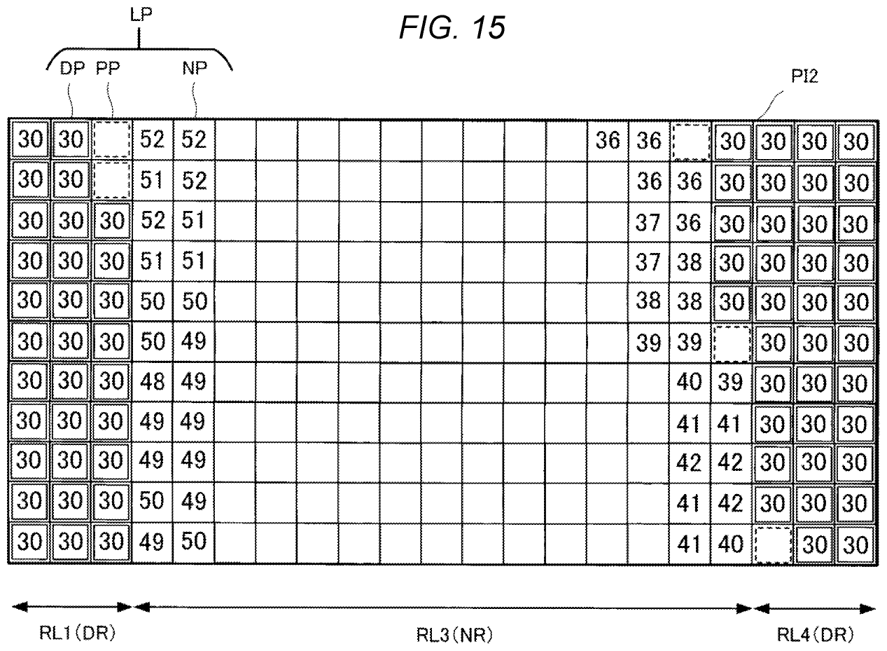

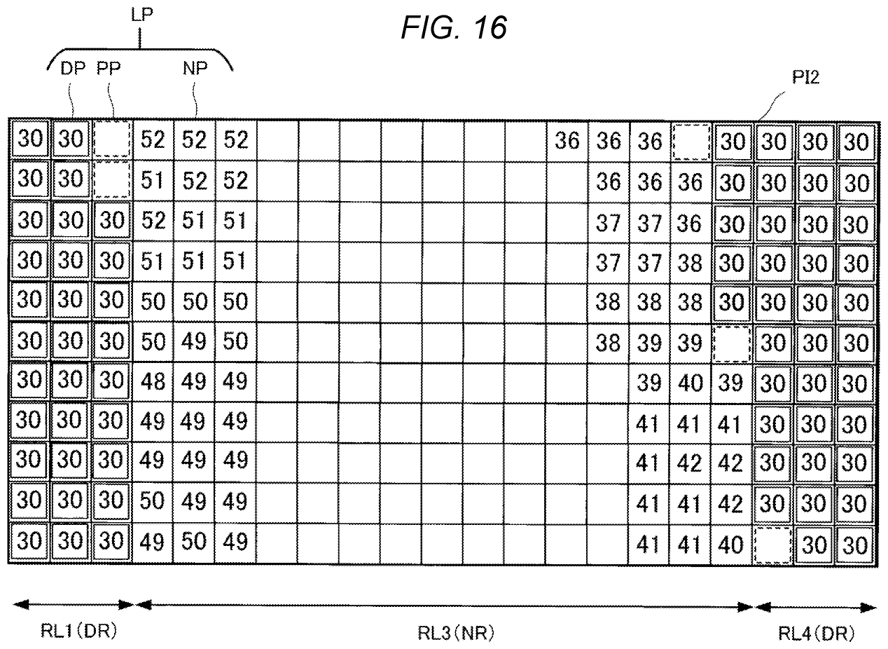

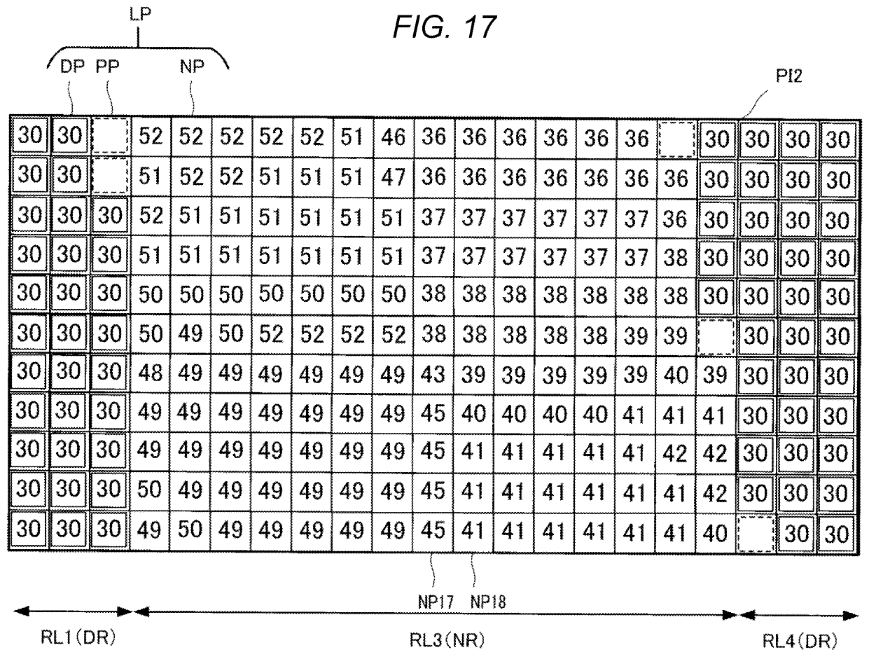

FIGS. 15 to 17 are diagrams illustrating the calculation of the target value of the brightness at the correction target point in the non-overlapping area. Compared to the state illustrated in FIG. 14, FIG. 15 illustrates a state in which the target gradation value t at the correction target point NP adjacent at the inner side of the non-overlapping area NR to the correction target point NP adjacent to the boundary between the overlapping area DR and the non-overlapping area NR is calculated. FIG. 16 illustrates a state in which the target gradation value t at the correction target point NP adjacent at the inner side of the non-overlapping area NR to the correction target point NP in the state shown in FIG. 15 is calculated. FIG. 17 illustrates a state in which the target gradation values t at all the correction target points NP are calculated.

In step SS4[5] in FIG. 11, the processing device 13 which functions as the correction value calculator 134 repeats smoothing of the target gradation value t at the correction target point NP other than the correction target point NP adjacent to the boundary between the overlapping area DR and the non-overlapping area NR out of the calculated target gradation values t. Specifically, the processing device 13 performs smoothing on the correction target points NP other than the correction target points NP adjacent to the boundary described above using the target gradation value t at the valid correction target point NP out of the correction target points NP adjacent upward, downward, leftward, and rightward thereto.

As illustrated in FIG. 17, when calculating the target gradation value t at the correction target point NP, the processing device 13 sequentially calculates the target gradation values t at the correction target points NP adjacent at the inner side of the non-overlapping area NR, that is, at the right side from the area RL1 which is one overlapping area DR. At the same time, the processing device 13 sequentially calculates the target gradation values t at the correction target points NP adjacent at the inner side of the non-overlapping area NR, that is, at the left side from the area RL4 which is the other overlapping area DR. Therefore, in the example illustrated in FIG. 17, a large difference occurs between the target gradation value t=45 at the correction target point NP17 and the target gradation value t=41 at the correction target point NP18 adjacent to the correction target point NP17. In other words, a step is generated between the target gradation value t=45 at the correction target point NP17 and the target gradation value t=41 at the correction target point NP18.

The processing device 13 performs the smoothing such that the step in the interpolated target gradation values t is eliminated and the target gradation values t at the correction target points NP belonging to the non-overlapping area NR are smoothly continued from the area RL1, which is the one overlapping area DR, toward the area RL4, which is the other overlapping area DR. As a result, the target gradation value t which is a parameter defining the brightness of the area RL3, which is the non-overlapping area NR, has a continuous or stepwise distribution in the direction from the area RL1 toward the area RL4.

In step SS4[6] in FIG. 11, the processing device 13 which functions as the correction value calculator 134 determines whether a variation width of the target gradation values t at the correction target points NP is equal to or less than a threshold value before and after the smoothing. More specifically, the processing device 13 determines whether a maximum value of the variation width of the target gradation values t at all the correction target points NP is equal to or less than the threshold value. When the maximum value of the variation widths of the target gradation values t at all the correction target points NP is equal to or less than the threshold value (“YES” in step SS4[6]), the processing device 13 executes processing in step SS4[7]. On the other hand, when the maximum value of the variation widths of the target gradation values t at all the correction target points NP exceeds the threshold value (“NO” in step SS4[6]), the processing device 13 executes the processing in step SS4[5]. The processing device 13 may determine whether at least one of the average value, (the average value)+30, and the sum of the variation widths of the target gradation values t at the correction target points NP is equal to or less than the threshold value before and after the smoothing.

That is, the processing device 13 repeats smoothing until the maximum value of the variation width of the target gradation values t at all the correction target points NP becomes equal to or less than the threshold value. As the number of times of the smoothing processing increases, the difference in the target gradation value t between the correction target points NP adjacent to each other decreases as a whole.

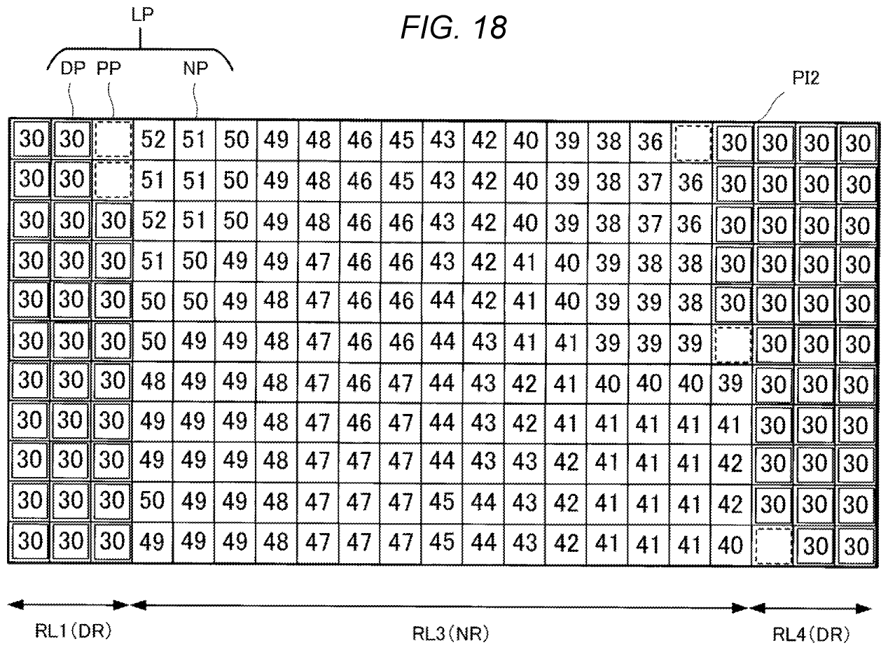

FIG. 18 is a diagram illustrating smoothing of the target value of brightness at the correction target point NP. FIG. 18 illustrates an example of the target gradation value t after the eighteenth smoothing processing. As illustrated in FIG. 18, when the maximum value of the variation width of the target gradation values t at all the correction target points NP is equal to or less than the threshold value, the smoothing is completed.

In step SS4[7] in FIG. 11, the processing device 13 which functions as the correction value calculator 134 calculates the target chromaticity at the correction target point NP belonging to the non-overlapping area NR and the target chromaticity at the correction target point DP belonging to the overlapping area DR.

Specifically, the processing device 13 calculates, as the XYZ value, the output luminance when the target gradation value (t, t, t) is input with respect to all the valid correction target points LP. Here, the target gradation value (t, t, t) takes a different value for each correction target point NP. Further, the target gradation value (t, t, t) takes a different value for each correction target point DP. Further, the target gradation value (t, t, t) at the correction target point NP is different from the target gradation value (t, t, t) at the correction target point DP.

In addition, the processing device 13 converts the calculated output luminance from the XYZ value into u′ and v′ using Formula 14 described above.

Further, the processing device 13 calculates the maximum value u′max and the minimum value u′min of the u′ value and the maximum value v′max and the minimum value v′min of the v′ value in u′ and v′ after the conversion for all the correction target points LP of all the projection apparatuses 10. As described above, in step SS4[7], the processing device 13 which functions as the correction value calculator 134 obtains u′ and v′ based on the target value of brightness for each of the plurality of correction target points LP to thereby obtain u′ and v′ groups, and then obtains the maximum value u′ₘₐₓ, the minimum value u′ₘᵢₙ, the maximum value v′ₘₐₓ, and the minimum value v′ₘᵢₙ from the obtained u′ and v′ groups.

Subsequently, the processing device 13 calculates the target chromaticity (u′_{target}, v′_{target}) based on the maximum value u′ₘₐₓ, the minimum value u′ₘᵢₙ, the maximum value v′ₘₐₓ, and the minimum value v′ₘᵢₙ. For this calculation, for example, Formula 15 described below is used.

$${u}_{target}^{′} = \frac{{u}_{max}^{′} + {u}_{min}^{′}}{2} {v}_{target}^{′} = \frac{{v}_{max}^{′} + {v}_{min}^{′}}{2} \qquad [ 15 ]$$

As described above, in step SS4[7], the processing device 13 which functions as the correction value calculator 134 sets the target chromaticity (u′_{target}, v′_{target}) to the chromaticity that minimizes the chromaticity difference between the plurality of correction target points LP based on the maximum value u′ₘₐₓ, the minimum value u′ₘᵢₙ, the maximum value v′ₘₐₓ, and the minimum value v′ₘᵢₙ for each of the plurality of correction target points LP.

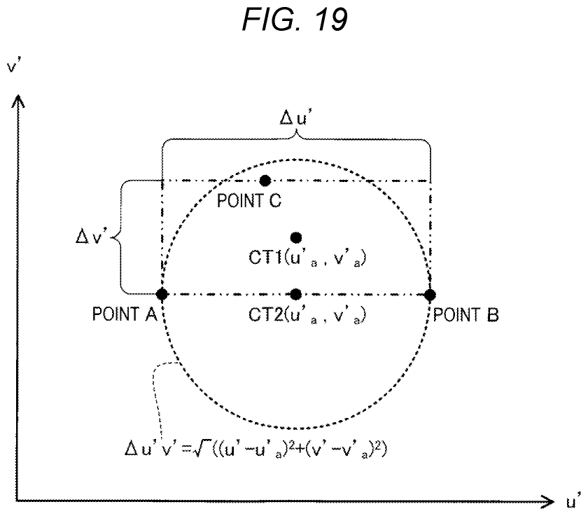

FIG. 19 is a diagram illustrating the target chromaticity (u′_{target}, v′_{target}). In FIG. 19, a point A at which each of the u′ value and the v′ value is the minimum value, a point B at which the u′ value is the maximum value and the v′ value is the minimum value, a point C at which the v′ value is the maximum value, the target chromaticity CT1 (u′ₐ, v′ₐ), and the target chromaticity CT2 (u′ₐ, v′ₐ) are shown in a u′-v′ coordinate.

The target chromaticity CT1 (u′ₐ, v′ₐ) corresponds to the target chromaticity (u′_{target}, v′_{target}) using Formula 15 described above. That is, the target chromaticity CT1 (u′ₐ, v′ₐ) is a point at which each of Δu′ and Δv′ is minimum, and corresponds to the center of the minimum rectangle including all of the points A, B, and C. Here, Δu′ and Δv′ are Δu′=|u′ₙ−u′ₐ| and Δv′=|v′ₙ−v′ₐ| when the chromaticity of each point is (u′ₙ, v′ₙ). Here, n is a natural number no smaller than 1 and no larger than N, N is the number of measurement points, and is (21 points in the horizontal direction)×(11 points in the vertical direction) in the present embodiment. In FIG. 19, three measurement points out of the plurality of measurement points are representatively shown as points A, B, and C. As in the present embodiment, when the chromaticity is denoted by u′ and v′, the target chromaticity CT1 (u′ₐ, v′ₐ) is used as the target chromaticity (u′_{target}, v′_{target}). When the chromaticity is also denoted by u and v or x and y, substantially the same target value as the target chromaticity CT1 is used.

Incidentally, the target chromaticity CT2 (u′ₐ, v′ₐ) is a point at which the chromaticity difference Δu′v′ is minimized, and corresponds to the center of a minimum circle including all of the points A, B, and C. Specifically, all circles each having a diameter connecting two points out of a plurality of u′ and v′ corresponding one-to-one to the plurality of correction target points LP and all circles each passing through three points out of the plurality of u′ and v′ are obtained, and a circle including u′ and v′ of each correction target point LP and having the smallest diameter is selected from these circles. The center of that circle is the chromaticity which minimizes the chromaticity difference Δu′v′, that is, the target chromaticity CT2 (u′ₐ, v′ₐ). Here, the chromaticity difference Δu′v′ is Δu′v′=\sqrt{(u′ₙ−u′ₐ)²+(v′ₙ−v′ₐ)²}. When the chromaticity is u′v′, the target chromaticity CT2 (u′ₐ, v′ₐ) may be used as the target chromaticity (u′_{target}, v′_{target}). When the chromaticity is uv or xy, substantially the same target value as the target chromaticity CT2 is used.

As described above, in step SS4[7], the target chromaticity (u′_{target}, v′_{target}) is calculated.

In step SS4[8] in FIG. 11, the processing device 13 which functions as the correction value calculator 134 calculates the correction value of the chromaticity at the correction target point NP belonging to the non-overlapping area NR and the correction value of the chromaticity at the correction target point DP belonging to the overlapping area DR based on the target value of the brightness at the correction target point DP belonging to the overlapping area DR and the target chromaticity (u′_{target}, v′_{target}) such that the brightness in the non-overlapping area NR is substantially equal to the brightness in the overlapping area DR in a state in which the construction of the multi-projection system is completed.

Specifically, the processing device 13 calculates the correction value at the correction target point LP in consideration of the target chromaticity (u′_{target}, v′_{target}) in the following procedure.
(Procedure 1) An XYZ value is calculated for each correction target point LP based on the target gradation value of brightness and Formulas 10 to 13. Here, the target gradation value of brightness refers to the target gradation value (r, g, b) as the target value of brightness at the correction target point DP and the target gradation value (r, g, b) as the target value of brightness at the correction target point NP.
(Procedure 2) Based on Formula 14, the X value and the Z value are calculated that the target chromaticity (u′_{target}, v′_{target}) is achieved at the Y value obtained in Procedure 1.
(Procedure 3) The XYZ values calculated in Procedure 1 and Procedure 2 are converted into RGB values based on Formula 13, and those RGB values are set as target RGB values.
(Procedure 4) Based on the relationship shown in FIG. 13, an input gradation is calculated so as to achieve the target RGB values for each correction target point LP. The input gradation in Procedure 4 is the correction value to be set for the correction target point LP, and is a gradation directly or indirectly input to the pixel corresponding to the correction target point LP out of the plurality of pixels of the liquid crystal panel.

Regarding the pixels other than the pixels corresponding to the correction target points LP out of the plurality of pixels, for example, the processing device 13 sets the correction values of several pixels around the pixel corresponding to the correction target point LP to the same value as the correction value of the pixel corresponding to the correction target point LP.

In step S5 in FIG. 6, the processing device 13 which functions as the correction value calculator 134 sets the correction value calculated in step S4 as a setting value. As a result, in step S5, the processing device 13 which functions as the corrector 136 corrects the chromaticity at each of the plurality of correction target points LP based on the target chromaticity (u′_{target}, v′_{target}).

In FIG. 2, the image acquired by the processing device 13 which functions as the image acquisition unit 135 is corrected based on the set correction value. As a result, the projection image PI in which the color unevenness of black and “black floating” are corrected is projected from the optical device 11 onto the projection surface SC.

In the above control method, since the target chromaticity (u′_{target}, v′_{target}) is set to the chromaticity at which the chromaticity difference between the plurality of correction target points LP is minimized based on the maximum value and the minimum value of the u′ and v′ groups, it is possible to make the chromaticity difference after the correction small when the correction amount is insufficient at the time of correction of the chromaticity.

### 2: MODIFIED EXAMPLES

The aspect described above can be variously modified. Specific aspects of the modification will be exemplified below. The aspects exemplified below and the aspects described in the above embodiment can be combined as appropriate within a range where no mutual contradiction is involved. Note that, in the modified examples exemplified below, elements equivalent in actions and functions to those of the embodiment are denoted by the same reference numerals and signs referred to in the above description to omit detailed descriptions of the respective elements as appropriate.

### 2-1: Modified Example 1

In the embodiment described above, the aspect in which the projection system 1 includes the plurality of projection apparatuses 10 is exemplified, but the present disclosure is not limited to this aspect, and the number of projection apparatuses 10 provided to the projection system 1 is not limited to a plural number and may be a singular number. When the number of projection apparatuses 10 provided to the projection system 1 is a singular number, each of the plurality of correction target points LP is a point in an image projected from one projection apparatus 10. Even in this case, it is possible to obtain the advantage that it is possible to appropriately correct the chromaticity of black in the image. The target value of brightness in the present modified example may be different from or the same as the target value of brightness in the embodiment described above.

### 2-2: Modified Example 2

In the embodiment described above, the aspect in which smoothing is performed such that the gradation values (t, t, t) as the target values at the correction target points NP belonging to the non-overlapping area NR are smoothly continued from the area RL1 which is one overlapping area DR toward the area RL4 which is the other overlapping area DR is exemplified, but the present disclosure is not limited to this aspect.

For example, the smoothing may be performed such that the brightness component Y of the target value at the correction target point NP belonging to the non-overlapping area NR is smoothly continued from the area RL1 which is one overlapping area DR toward the area RL4 which is the other overlapping area DR.

### 3: SUMMARY OF PRESENT DISCLOSURE

The present disclosure will be summarized below as appendices.
(Appendix 1) A first aspect as a preferred example of a control method according to the present disclosure is a method of controlling at least one projection apparatus configured to project a plurality of images different in brightness from each other, the method comprising: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity of each of the plurality of correction target points based on the target chromaticity. In the aspect described above, since the target chromaticity is set to the chromaticity at which the chromaticity difference between the plurality of correction target points is minimized based on the maximum value and the minimum value of the u′ and v′ groups, it is possible to make the chromaticity difference after the correction small when the correction amount is insufficient at the time of correction of the chromaticity.
(Appendix 2) A second aspect as a preferred example of a projection apparatus according to the present disclosure is a projection apparatus configured to project a plurality of images different in brightness from each other including at least one processor, wherein the processor is configured to execute: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity at each of the plurality of correction target points based on the target chromaticity.

In the aspect described above, since the target chromaticity is set to the chromaticity at which the chromaticity difference between the plurality of correction target points is minimized based on the maximum value and the minimum value of the u′ and v′ groups, it is possible to make the chromaticity difference after the correction small when the correction amount is insufficient at the time of correction of the chromaticity.
(Appendix 3) A third aspect as a preferred example of a non-transitory computer-readable storage medium storing a program according to the present disclosure is a non-transitory computer-readable storage medium storing a program for controlling at least one projection apparatus including a processor and configured to project a plurality of images different in brightness from each other, the program causing the processor to execute processing including: acquiring chromaticity at which the brightness of each of a plurality of correction target points becomes a target value; setting, as target chromaticity, chromaticity at which a chromaticity difference between the plurality of correction target points becomes minimum at each of the plurality of correction target points; and correcting the chromaticity at each of the plurality of correction target points based on the target chromaticity.

In the aspect described above, since the target chromaticity is set to the chromaticity at which the chromaticity difference between the plurality of correction target points is minimized based on the maximum value and the minimum value of the u′ and v′ groups, it is possible to make the chromaticity difference after the correction small when the correction amount is insufficient at the time of correction of the chromaticity.

What is claimed is:

1. A method of controlling at least one projection apparatus configured to project a plurality of images different in brightness from each other, the method comprising:
acquiring chromaticity at which the brightness of each of a plurality of correction target points becomes a target value;
setting, as target chromaticity, chromaticity at which chromaticity difference between the plurality of a correction target points becomes minimum at each of the plurality of correction target points; and
correcting the chromaticity at each of the plurality of correction target points based on the target chromaticity.

2. A projection apparatus configured to project a plurality of images different in brightness from each other comprising
at least one processor, wherein
the processor is configured to execute:
acquiring chromaticity at which the brightness of each of a plurality of correction target points becomes a target value;
setting, as target chromaticity, chromaticity at which a chromaticity difference between the plurality of correction target points becomes minimum at each of the plurality of correction target points; and
correcting the chromaticity at each of the plurality of correction target points based on the target chromaticity.

3. A non-transitory computer-readable storage medium storing a program for controlling at least one projection apparatus including a processor and configured to project a plurality of images different in brightness from each other, the program causing the processor to execute processing comprising:
acquiring chromaticity at which the brightness of each of a plurality of correction target points becomes a target value;
setting, as target chromaticity, chromaticity at which a chromaticity difference between the plurality of correction target points becomes minimum at each of the plurality of correction target points; and
correcting the chromaticity at each of the plurality of correction target points based on the target chromaticity.
